(19) United States
(12) Patent Application Publication
(10) Pub. No.: US 2010/0143561 A1
(43) Pub. Date: Jun. 10, 2010

(54) PET FOOD AND A PROCESS FOR ITS MANUFACTURE

(75) Inventors: Diego Marco-Martinez, Bremen (DE); Erik Bogsch, Bremen (DE); Gudrun Steppich, Achim (DE); Thomas Brenten, Hoya (DE)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 12/595,594

(22) PCT Filed: Apr. 25, 2008
(86) PCT No.: PCT/EP08/03353

§ 371 Date: Nov. 4, 2009

(30) Foreign Application Priority Data
May 7, 2007 (DE) 10 2007 021 227.7
Mar. 13, 2008 (DE) 10 2008 014 088.0

(51) Int. Cl. A23K 1/00; A23K 1/16; A23K 1/18

(52) U.S. Cl. 426/534

(57) ABSTRACT

The present invention relates to pet food with a predetermined concentration of butyric acid, 3-methylbutyric acid and/or salt thereof as well as a process for its manufacture.

The present invention relates to a pet food as well as a process for its manufacture.

Pet food is known in multiple variations, whether as moist or dry pet food. Such pet foods have different ingredients and tastes. Pet food based on beef and chicken ingredients is well known. Meatless pet food is known, too. It is essentially based on cereals.

The palatability of the known pet foods can still be improved.

The invention has therefore set itself the object to provide a pet food which animals, preferably dogs, accept even more readily and which they find more palatable. Also, one object is to provide a process for the manufacture of such pet food.

The first problem is solved by a pet food containing neither rumen nor liver and having a concentration of butyric acid of 5 ppm to 10,000 ppm and/or a concentration of 3-methylbutyric acid of 4 ppm to 10,000 ppm, and/or salt thereof.

Preferably, the pet food has a concentration of butyric acid of 5 to 1000 ppm, preferably 6 to 200 ppm, and/or a concentration of 3-methylbutyric acid of 4 to 500 ppm, preferably 5 to 200 ppm, and/or salt thereof.

Alternatively, a pet food can be provided that contains liver but not rumen and that has a concentration of butyric acid of 7 ppm to 10,000 ppm and/or a concentration of 3-methylbutyric acid of 4 ppm to 10,000 ppm, and/or salt thereof.

Preferably, the pet food has a concentration of butyric acid of 10 to 1,000 ppm, preferably 12 to 500 ppm, and/or a concentration of 3-methylbutyric acid of 4 to 500 ppm, preferably 5 to 200 ppm, and/or salt thereof.

As a further alternative, a pet food can be provided that contains rumen and that has a concentration of butyric acid of 20 to 10,000 ppm and/or a concentration of 3-methylbutyric acid of 4 ppm to 10,000 ppm, and/or salt thereof.

Preferably, the pet food has a concentration of butyric acid of 22 to 1,000 ppm, preferably 30 to 500 ppm, and/or a concentration of 3-methylbutyric acid of 4 to 500 ppm, preferably 5 to 200 ppm, and/or salt thereof.

In a most preferred embodiment, a pet food containing rumen has a content of butyric acid of at least 100 ppm.

Furthermore, it can be provided that the pet food contains beef liver, pork liver, and/or chicken liver.

It is also preferable that it contains C₂-C₁₀ fatty acids other than butyric acid and 3-methylbutyric acid.

Preferred acids are selected from among acetic acid, propionic acid, isobutyric acid, 2-methylbutyric acid, pentanoic acid, hexanoic acid, 2-methylpentanoic acid, 4-methylpentanoic acid, 2-methyl-2-pentanoic acid and mixtures of these acids. Preferably, these acids are added in an additional amount exceeding the amount that is naturally contained in the pet food.

According to the invention, the term “rumen” also comprises “tripe”. To the inventive pet food butyric and/or 3-methylbutyric acid can be added. Of course, also one or more suitable salts thereof may be added, preferably salts of sodium, potassium, calcium and/or ammonium, either alone or in combination with one or more acids.

Using the salts no diminished acceptance of the animals is observed.

It is preferred that the butyric acid, 3-methylbutyric acid and/or salts thereof are encapsulated in the pet food in capsules.

In one embodiment the capsule material is maltodextrin, sugar, a derivative of sugar, fats having high melting point, derivates of cellulose, such as carboxymethylcellulose (CMC), ethylcellulose, methylcellulose, hydroxypropylmethylcellulose (HPMC), calciumalginate, calciumpectinate, gelatine, zein, albumin-protein, whey protein isolate, soya isolate, lupine isolate, chitosan or high-amylose-starch.

Even preferred is that the size of the capsule is 10 μm to 200 μm.

A further alternative is the addition of functional components, such as acetoin(3-hydroxy-2-butanone) and/or diacetyl(2,3-butandione).

Preferably, the pet food is moist or dry pet food. It is especially preferable that it is dog or cat food.

The second problem is solved by a process for the manufacture of a pet food according to the invention, characterised by the steps of mixing pet food components with butyric acid and/or 3-methylbutyric acid, packaging the obtained mixture into a container, sealing the container and sterilising the container.

In one alternative embodiment the pet food components are provided, a respective content of butyric acid, 3-methylbutyric acid or salts thereof is adjusted by fermentation by addition of a fermentation agent, the obtained mixture is packaged into a container, the container is sealed and the container is sterilized.

It is preferred that the fermentation is achieved by bacterial, fungal or cell cultures or by addition of enzymes.

The use of an additive of butyric acid and/or 3-methylbutyric acid in the manufacture of pet food is further provided.

Finally, it is preferred that the pet food is for dogs or cats.

The amount of butyric acid, 3-methylbutyric acid and salts thereof in ppm is based on the overall weight of the pet food.

Surprisingly, it was found that animals, in particular dogs, particularly prefer and eat pet food that has a certain concentration of butyric acid and/or 3-methylbutyric acid. The acids used according to the invention are volatile at room temperature. Therefore, they make a considerable contribution to the aroma of the pet food. Furthermore, the inventors—without restricting themselves to any theory—assume that dogs, in particular, like a buttery aroma such as the aroma of matured cheese, for example.

Within the scope of the present invention, the term “pet food” is to be understood as animal food that is fed to dogs, cats, conies or guinea pigs, for example. Contrary to pet food, fodder is to be understood as animal food fed to cattle, sheep or horses, for example.

It was found that if the pet food according to the invention contains rumen—which already has a natural concentration of 19 ppm butyric acid and around 1.5 ppm 3-Methylbutyric acid-, increasing the amounts of these acids can make the pet food even more palatable. This is because animals prefer such a pet food to pet food that does not contain a respective additive. This will be described in further detail below in the description of the embodiments.

If the pet food according to the invention contains liver, for example beef liver and/or chicken liver, which have a natural concentration of around 1 ppm butyric acid and around 1 ppm 3-methylbutyric acid, such pet food can be made more palatable, too, by further adding butyric acid and/or 3-methylbutyric acid.

Pet food containing neither rumen nor liver can be made palatable, according to the invention, by adding small amounts of butyric acid and/or 3-methylbutyric acid.

Butyric acid and/or 3-methylbutyric acid can be added to the pet food from an external source. It is also possible to produce the acids in a fermentation process. In one embodiment of the process for the manufacture of pet food according to the invention, fermentation is essentially avoided given that the pet food is packaged into a sealed and sterilised container.

In an alternative embodiment, butyric acid, 3-methylbutyric acid or salts thereof are provided by fermentation by addition of a fermentation agent, whereupon the mixture obtained is then packaged in a container, the container is sealed and sterilized.

Butyric acid and/or 3-methylbutyric acid can be added in pure form or via a substrate. The additive can be liquid or solid, preferably in powder form.

Further features and advantages of the invention will become clear from the following detailed description of the preferred embodiments, which should, however, not be interpreted in any way that limits the scope of the invention.

### EXAMPLE 1

A common pet food was produced, consisting of 30 to 60 percent by weight meat or fish materials, 10 to 30 percent by weight wheat flour or maize starch, 5 to 12 percent by weight fibroid material, 10 to 30 percent by weight water and other common additives such as vitamins, minerals, etc. This pet food did not contain rumen or liver. 12 ppm butyric acid were added to a part of the pet food and were blended in smoothly. The specifications in ppm refer to the total weight of the pet food. Pet food with no butyric acid added to it was filled into a feeding bowl, and pet food with butyric acid added to it was filled into another bowl. Both bowls were simultaneously offered to a dog. This test was repeated with a total of around 30 dogs. It was observed that it was the pet food with butyric acid added to it which the dogs preferred on average. While the dogs ate an average of about 70% of the offered pet food with butyric acid added to it, they only ate an average of about 30% of the untreated pet food. This shows clearly that the pet food that has butyric acid added to it is more palatable than the untreated pet food. Surprisingly, it was also observed that big dogs, that is dogs weighing more than about 15 kg, particularly preferred the pet food that had butyric acid added to it.

### EXAMPLE 2

A pet food was produced according to Example 1. This pet food, however, had a concentration of 50 percent by weight liver. 20 ppm butyric acid were added to a part of this pet food. The native concentration of butyric acid in the liver used amounted to 1.1 ppm.

The test procedure as described in Example 1 was then repeated. Again, it was observed that it was the pet food that had butyric acid added to it which the dogs clearly preferred.

### EXAMPLE 3

A pet food was produced according to Example 1. This pet food, however, had a concentration of 20 percent by weight rumen. Therefore, the untreated pet food had a concentration of around 7 ppm butyric acid. 20 ppm butyric acid were added to a part of this untreated pet food. The test procedure described in Example 1 was carried out for this pet food, too. Again, it was observed that it was the pet food that had butyric acid added to it which the dogs clearly preferred.

### EXAMPLE 4

A pet food was produced as described in Example 1. However, 10 ppm 3-methylbutyric acid were added instead of butyric acid. The test procedure described in Example 1 was carried out. Again, it was observed that it was the pet food that had 3-methylbutyric acid added to it which was clearly more palatable and which the dogs preferred.

### EXAMPLE 5

Based on the pet food described in Example 1, tests were carried out involving 50, 100, 500, 1,000, 2,000, 5,000 and 10,000 ppm butyric acid. The same procedure as in Example 1 was carried out. Again, it was observed that the dogs clearly preferred the pet food containing butyric acid.

Thus, the above-mentioned results clearly show that the pet food according to the invention is clearly more advantageous than conventional pet food as regards palatability. The thus produced pet food can easily be produced on an industrial scale by mixing the common pet food components with butyric acid and/or 3-methylbutyric acid, subsequently packaging the obtained mixture into a container, preferably a tin, then sealing the container and subsequently sterilising it.

The features of the invention disclosed in the preceding description and in the claims may be material both individually and in any combination for reducing the invention to practice in its different embodiments.

1. Pet food, containing neither rumen nor liver, with a concentration of butyric acid of 5 ppm to 10,000 ppm and/or a concentration of 3-methylbutyric acid of 4 ppm to 10,000 ppm, and/or salt thereof.

2. Pet food as claimed in claim 1, characterised in that it has a concentration of butyric acid of 5 to 1,000 ppm, preferably 6 to 200 ppm, and/or a concentration of 3-methylbutyric acid of 4 to 500 ppm, preferably 5 to 200 ppm, and/or salt thereof.

3. Pet food, containing liver but not rumen, with a concentration of butyric acid of 7 to 10,000 ppm and/or a concentration of 3-methylbutyric acid of 4 to 10,000 ppm, and/or salt thereof.

4. Pet food as claimed in claim 3, characterised in that it has a concentration of butyric acid of 10 to 10,000 ppm, preferably 12 to 500 ppm, and/or a concentration of 3-methylbutyric acid of 4 to 500 ppm, preferably 5 to 200 ppm, and/or salt thereof.

5. Pet food, containing rumen, with a concentration of butyric acid of 20 to 10,000 ppm and/or a concentration of 3-methylbutyric acid of 4 to 10,000 ppm, and/or salt thereof.

6. Pet food as claimed in claim 5, characterised in that it has a concentration of butyric acid of 22 to 1,000 ppm, preferably 30 to 500 ppm, and/or a concentration of 3-methylbutyric acid of 4 to 500 ppm, preferably 5 to 200 ppm, and/or salt thereof.

7. Pet food as claimed in either of claim 3 or 4, characterised in that it contains beef liver and/or chicken liver.

8. Pet food as claimed in any of the preceding claims, characterised in that it contains C₂-C₁₀ fatty acids other than butyric acid and 3-methylbutyric acid.

9. Pet food as claimed in claim 8, characterised in that the fatty acids are selected from among acetic acid, propionic acid, isobutyric acid, 2-methylbutyric acid, pentanoic acid, hexanoic acid, 2-methylpentanoic acid, 4-methylpentanoic acid, 2-methyl-2-pentanoic acid and mixtures of these acids.

10. Pet food as claimed in any of the preceding claims, wherein the butyric acid, 3-methylbutyric acid and/or salts thereof are encapsulated in the pet food in capsules.

11. Pet food according to claim 10, wherein the capsule material is maltodextrin, sugar, a derivative of sugar, fats having high melting point, derivates of cellulose, such as carboxymethylcellulose (CMC), ethylcellulose, methylcellulose, hydroxypropylmethylcellulose (HPMC), calciumalginate, calciumpectinate, gelatine, zein, albumin-protein, whey protein isolate, soya isolate, lupine isolate, chitosan or high-amylose-starch.

12. Pet food according to claim 10 or 11, characterized in that the size of the capsule is 10 μm to 200 μm.

13. Pet food as claimed in any of the preceding claims, characterised in that it is a moist or dry pet food.

14. Pet food as claimed in any of the preceding claims, characterised in that it is dog or cat food.

15. Process for the manufacture of a pet food as claimed in any of the preceding claims, characterised in the steps of mixing pet food components with butyric acid and/or 3-methylbutyric acid, packaging the obtained mixture into a container, sealing the container and sterilising the container.

16. Process for the manufacture of a pet food as claimed in any of claims 1 to 14, characterized in that pet food components are provided, a respective content of butyric acid, 3-methylbutyric acid or salts thereof is adjusted by fermentation by addition of a fermentation agent, the obtained mixture is packaged into a container, the container is sealed and the container is sterilized.

17. Process according to claim 16, wherein the fermentation is achieved by bacterias, fungal or cell cultures or by addition of enzymes.

18. Use of an additive of butyric acid and/or 3-methylbutyric acid or salt thereof in the manufacture of pet food.

19. Use according to claim 18, characterized in that the pet food is for dogs or cats.
